(19) United States
(12) Patent Application Publication
(10) Pub. No.: US 2005/0270607 A1
(43) Pub. Date: Dec. 8, 2005

(54) System and methods for refractive and diffractive volume holographic elements

(76) Inventors: Christophe Moser, Pasadena, CA (US); Gregory Steckman, Glendora, CA (US); Wenhai Liu, Alhambra, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/092,149

(22) Filed: Mar. 28, 2005

Related U.S. Application Data
(60) Provisional application No. 60/558,212, filed on Mar. 30, 2004.

(51) Int. Cl. G02B 5/32

(52) U.S. Cl. 359/15

(57) ABSTRACT

A laser utilizes feedback from a volume holographic grating integrated in a collimating lens as a wavelength standard to lock the laser output wavelength to its desired value. This feedback is optical, wherein a volume hologram reflection grating is used to generate optical feedback into the laser gain region. Fabrication of the integrated volume hologram grating lens elements is by either first recording the grating in a rectangular parallelepiped of material and then shaping the lens from it, or alternatively by first shaping the material into the desired shape and then recording the grating with the use of an apparatus composed of an optical block within which a cavity is present to accept the lens and index matching fluid.

### RELATED APPLICATION

The applicant claims priority to provisional patent application No. 60/558,212 filed Mar. 30, 2004

### BACKGROUND OF THE INVENTION

1. Field of the Invention

The present invention relates to systems and methods for volume holographic elements and gratings used to control the output wavelength of laser sources and apparatus for their fabrication.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

Volume hologram reflection gratings have been shown to be an accurate and temperature-stable means of filtering a narrow passband of light from a broadband spectrum. This technology has been demonstrated in practical applications where narrow fill-width-at-half-maximum (FWHM) passbands ate required. Furthermore, such filters have arbitrarily selectable wavefront curvatures, center wavelengths, and output beam directions.

Photorefractive materials, such as LiNbO₃ crystals and certain types of polymers and glasses, have been shown to be effective media for storing volume holographic gratings such as for optical filters or holographic optical memories with high diffraction efficiency and storage density. In addition, volume gratings Bragg-matched to reflect at normal incidence have been used successfully to stabilize and lock the wavelength of semiconductor laser diodes (U.S. Pat. No. 5,691,989).

In the prior art, a refractive element, such as a collimating lens, is used in conjunction with the volume holographic grating. Currently the holographic element is a separate element from the collimating lens, and is placed in the path of the already collimated beam. This requires an additional element to be assembled and aligned to the laser relative to the standard collimated but free-running laser. The alignment can be a problem because of asymmetric sensitivities of the devices. For example, the collimating lens may be rotation insensitive but translation sensitive. Conversely, the holographic element may be translation insensitive while being rotation sensitive. Matching and alignment then becomes a complex operation.

FIG. 1 depicts a prior art approach to laser wavelength stabilization of a laser diode bar with a volume holographic grating (VHG). The emitters 101, 102, and 103 of the laser diode bar 100, are collimated in the fast axis with a cylindrical lens, 110. The VHG 120, is placed after the cylindrical lens. This construction requires the separate alignment and attachment of the collimating optic and the VHG. Although a cylindrical lens is shown in this example other types of lenses are also utilized, such as a D-lens. In the case of single emitters, cylindrical or spherical optics may be used.

Different methods of recording or fabricating volume holographic gratings have also been used depending on the wavelength of the recording laser, determined by the material's sensitivity, and the wavelength used for readout, dictated by the application. In the conventional case, when the readout wavelength is at or near the recording wavelength, the recording geometry is essentially the same as that for the readout. In addition, gratings Bragg-matched to reflect at normal incidence have been recorded using a technique of writing from the side face in a transmission mode geometry with the correct incidence angle and a shorter wavelength of light, where the sensitivity of the material is much higher than at the, typically longer, readout wavelength (U.S. Pat. No. 5,491,570).

### SUMMARY OF THE INVENTION

A laser utilizing feedback from a volume holographic grating integrated into a collimating lens used as a wavelength standard to lock the laser output wavelength to its desired value is described. This feedback is optical, with a volume hologram reflection grating integrated into a collimating lens used to generate optical feedback into the laser gain region.

In a first embodiment, the volume holographic grating consists of planar or curved surfaces of constant refractive index embedded throughout the volume of a collimating lens element. The lens can be a cylindrical or D type lens, or a spherical optic, or other form of collimating optic. Integration, of what in the prior art are two separate elements, reduces the complexity and cost of aligning and attaching the collimating and wavelength stabilizing components.

Another aspect of this invention is the method and apparatus of fabricating integrated elements. In one embodiment, the volume holographic grating is recorded through ordinary means in a slab of material. Then it is shaped into the desired shape of a lens. The recording can be with plane waves, to create planes of constant refractive index, or through the use of spherical or cylindrical wavefronts in order to create curved surfaces of constant refractive index.

In another embodiment, fabricating lens elements with integrated volume holographic gratings begins with a pre-formed material in which the recording is performed. The apparatus consists of a block of optical material within which one or more cavities are present to accept the unrecorded lenses. Within the cavity index-matching fluid is inserted to fill-in the space between the edge of the cavity and the lens. Due to the use of index matching fluid, it is not strictly necessary for the cavity shape to be the same as that of the lens element inserted into it. It must only be large enough for the lens to be able to be inserted and removed from the cavity. A usual holographic recording process is then used to expose the block with inserted lenses to record a grating with the desired characteristics.

### BRIEF DESCRIPTION OF THE DRAWINGS

These and other features, aspects and advantages of the present invention will become better understood with regard to the following description, appended claims and accompanying drawings where:

FIG. 1 is a schematic diagram of a prior art method of using a volume holographic grating to wavelength stabilize a laser diode bar.

FIG. 2 illustrates a volume holographic grating within a cylindrical lens.

FIGS. 3a and 3b are schematic depictions of planar and curved surfaces of constant refractive index within volume holographic grating lens elements.

FIG. 4 is a flow chart describing the steps involved in one method of fabricating a volume holographic lens element.

FIG. 5 is a flow chart describing the steps involved in another method of fabricating a volume holographic lens element.

FIG. 6 is a flow chart describing the steps involved in yet another method of fabricating a volume holographic lens element.

FIGS. 7a and 7b are schematic depictions of apparatus and methods of recording volume holographic gratings in lens elements.

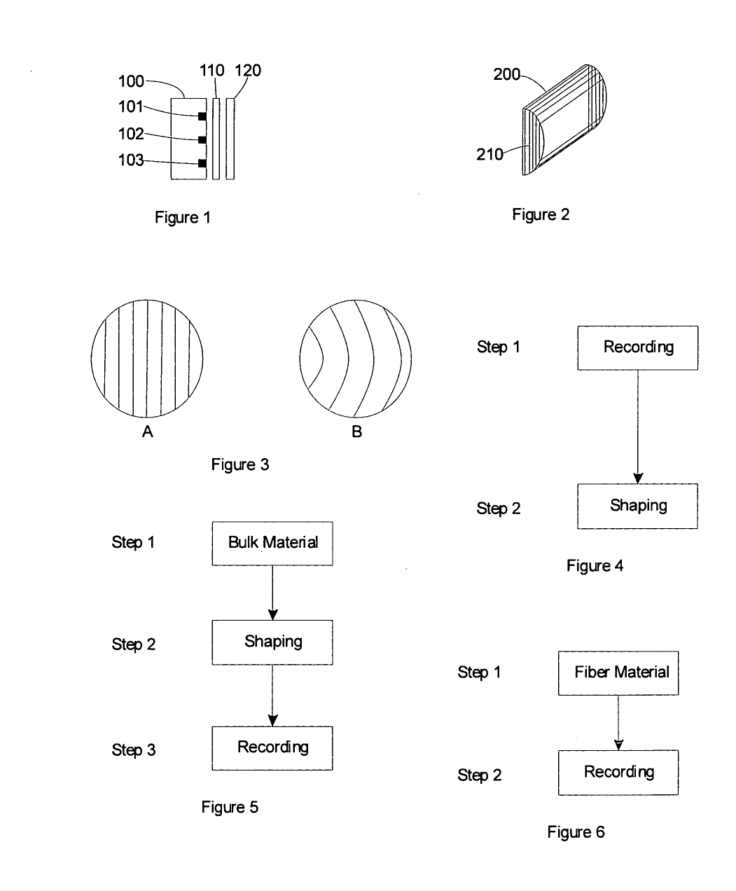

### DETAILED DESCRIPTION OF THE INVENTION

In the following description of the present invention, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Refractive and Diffractive Elements

FIG. 2 illustrates a lens 200, with an integrated VHG 210. The lens 200 can be a cylindrical or D type lens for use with laser diode bars, or a spherical optic for use with single emitters. As shown in FIG. 2, the lens 200 is integrated with the VHG, reducing part count and ease of assembly of the laser system.

In FIG. 3, a schematic diagram is shown of the lines of constant refractive index that make up the grating for two different conditions. A planar grating can be used, as shown in FIG. 3A, or the grating can be curved as shown in FIG. 3B. The overall diffraction efficiency of the lens integrated VHG can be increased by curving the grating planes such that they are phase matched to the phase curvature of the illuminating beam. The amount and type of grating plane curvature is not limited to the two forms shown in FIG. 3, but can take any form needed to improve the response of the VHG for a particular application.

Fabrication

The steps to fabricate a lens-shaped VHG element starting from a rectangular parallelepiped of material are shown in FIG. 4. At step 401, the VHG is recorded through ordinary means in a slab of material. This can be a two-beam holographic process, where the beams are generated with beam splitters, from a phase-mask, or by other means. At step 402 it is shaped into the desired shape of a lens. The shaping can be by etching, machining, or by other means that will not distort the grating already recorded in the material. The recording can be with plane waves, to create planes of constant refractive index, or through the use of spherical or cylindrical wavefronts in order to create curved surfaces of constant refractive index. The shaping must take into account the orientation of the grating in the original piece of material so that the final lens will have the grating in the correct orientation for operation.

An alternative means of fabricating lens elements with integrated VHG's is to begin with a pre-formed material in which the recording is performed. FIG. 5 illustrates a method for fabricating an integrated assembly when starting with a bulk glass material at step 501. At step 502 it is first shaped into the required lens shape, and then recorded at step 503. The shaping can be by etching, machining, molding, or by other means.

Alternatively, FIG. 6 illustrates a method for fabricating an integrated assembly when the material begins as a fiber with the desired cross-sectional shape at step 601. Glass and plastic fiber fabrication technology is well established and can produce many kilometers of optical material with a consistent cross-section over its length. This process doesn't require the initial shaping step. The long fiber can be cut into smaller lengths suitable for the application and the recording performed on individual or groups of pieces at step 602.

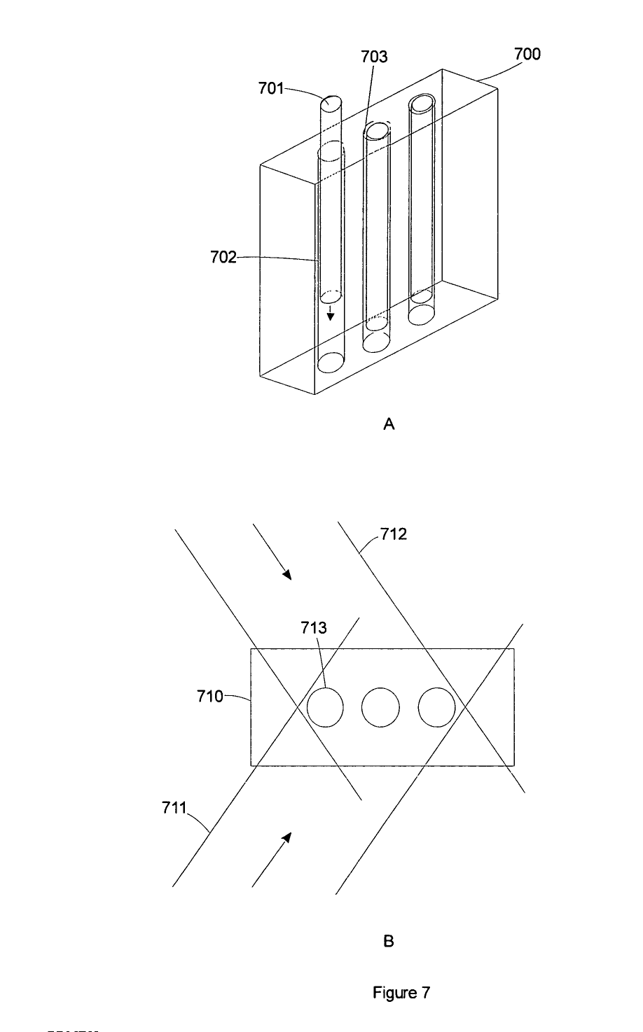

FIG. 7 illustrates a way of recording in material that already has a lens shape. FIG. 7A shows a block of optical material 700, which can be glass, quartz, plastic, or other material. The material chosen may depend on availability, cost, and refractive index. Within this block one or more cavities 702 are present to accept a lens 701 as shown. Within the cavity index matching fluid 703 is inserted to fill-in the space between the edge of the cavity and the lens. The index matching fluid reduces the effects of surface reflections, losses, and refraction. Due to the use of index matching fluid, it is not strictly necessary for the cavity shape to be the same as that of the lens element inserted into it. It must only be large enough for the lens to be able to be inserted and removed from the cavity.

FIG. 7B illustrates the use of the apparatus pictured in FIG. 7A in a 2-beam holographic recording system. The block 710, is placed in the path of two interfering beams 711 and 712, such that the cavities 713 are within the area of interference. The precise wavelength of light used and angle of incidence of the beams can be changed to record a wide range of holographic grating types within the lens elements. Different angles and/or wavelengths can change the fringe spacing. Using diverging or converging, spherical or cylindrical, beams will record curved fringes. Phase masks can be used to further tailor the wavefronts of the recording beams, which will be copied holographically into the lens elements. The use of a cavity and index matching fluid makes it simple to calculate the grating that will be recorded, because it is essentially the same as a standard rectangular parallelepiped of material which is the most familiar form used in the field of volume holography. Multiple cavities allow the recording of multiple pieces per exposure, increasing the throughput for volume manufacture.

Thus, systems, methods and apparatus are described in conjunction with one or more specific embodiments. The invention is defined by the claims and their full scope of equivalents.

1. A refractive element having at least one volume holographic grating.

2. The element of claim 1 where the refractive element collimates a propagating electro-magnetic wave.

3. The element of claim 1 where the refractive element is a cylindrical lens.

4. The element of claim 1 where the refractive element is a spherical lens.

5. The element of claim 1 where the refractive element is a D-lens.

6. The element of claim 1 where the refractive element is an aspheric lens.

7. The element of claim 1 where the refractive element is an aspheric cylindrical lens.

8. The element of claim 1 where the refractive element corrects astigmatism of the propagating electromagnetic wave.

9. The element of claim 1 where the element is composed of an array of sub-elements each of which modifies the wavefront of a corresponding propagating electromagnetic wave.

10. The element of claim 1 where the volume holographic grating has planar surfaces of constant refractive index.

11. The element of claim 1 where the volume holographic grating has curved surfaces of constant refractive index.

12. A method of fabricating an integrated refractive volume holographic element comprising the steps of:
recording a volume holographic grating in a material;
shaping the material into a refractive element.

13. An apparatus for recording a volume holographic grating in a refractive element comprising a medium consisting of one or more cavities into which pre-formed refractive elements are inserted together with index matching fluid;
recording a volume holographic grating using interfering recording beams.

14. A method of fabricating integrated refractive volume holographic elements comprising the steps of:
shaping a material into a desired refractive element;
recording a volume holographic grating in said refractive element.

15. The method of claim 14 wherein the step of recording is accomplished by inserting a preformed refractive element into a cavity of a material and recording the volume holographic grating using interfering recording beams.

16. A method of fabricating an integrated refractive volume holographic element comprising the steps of:
fabricating a material into a fiber with a desired cross-sectional shape to exhibit refractive properties;
recording a volume holographic grating in said refractive element.

17. The method of claim 16 wherein the step of recording is accomplished by inserting a preformed refractive element into a cavity of a material and recording the volume holographic grating using interfering recording beams.
